(19) United States
(12) Patent Application Publication
(10) Pub. No.: US 2010/0178143 A1
(43) Pub. Date: Jul. 15, 2010

(54) AXLELESS FLEX FLOOR TRAILER AND TRUCK

(76) Inventor: Judson Smith, Indianapolis, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 12/652,891

(22) Filed: Jan. 6, 2010

Related U.S. Application Data
(60) Provisional application No. 61/142,802, filed on Jan. 6, 2009.

(51) Int. Cl. B60P 1/64; B60P 1/02

(52) U.S. Cl. 414/498; 414/495; 414/812

(57) ABSTRACT

Apparatus and methods for transporting a container on a trailer. In some embodiments, the containers are modular, and the trailer can accommodate one or two containers. In some embodiments, the trailer has a U-shaped platform that can be lowered to slide inbetween the bottom of the containers and the roadway for purposes of loading the containers. The trailer can then be restored to a transport position for moving the containers over a roadway.

### CROSS REFERENCE TO RELATED APPLICATION

This application claims the benefit of priority to U.S. Provisional Patent Application Ser. No. 61/142,802, filed Jan. 6, 2009, entitled AXLELESS FLEX FLOOR TRAILER AND TRUCK, incorporated herein by reference.

### FIELD OF THE INVENTION

Certain embodiments of the inventions herein pertain to apparatus and methods for transporting a container, and in particular to a trailer for transporting a standardized container.

### BACKGROUND OF THE INVENTION

There is an increasing need for storage containers that can be filled with cargo, transported to a location, and then stored at the location with the cargo still present. Such containers offer versatility for the user, since the same container is used for both transportation and long term storage.

However, the containers and trailers can be bulky and sometimes complicated to load. For example, one design includes a winching apparatus for lifting the container onto the trailer. Yet another trailer includes simple forklift-type lifting arms that may not properly position the cargo for transport. In yet other cases, the container is so large that its cost is excessive for many users.

What is needed is a container and trailer system that provides an easy to use and economical method for transporting and storing cargo, which can be found in some of the embodiments shown herein.

### SUMMARY OF THE INVENTION

One aspect of the present invention pertains to a container having a bottom with a periphery, the bottom including a downwardly extending support structure that is recessed inwardly from the periphery of each side to define ledges on sides of the bottom, the front of the container including a first alignment feature. Some embodiments further include a trailer including a front section and two side sections in a general U-shape, the opened central portion of the U being sized to accept the support structure. The trailer includes a second alignment feature capable of coupling with the first alignment feature to align the container relative to the trailer.

Another embodiment of the present invention pertains to a method for transporting a container on a road. Some embodiments include providing a container and a trailer having a platform with a U-shape. Yet other embodiments further include supporting the container at a first vertical height above the road and supporting the top of the platform of the trailer at a second vertical height above the road, sliding the opened portion of the U underneath the container, and laterally aligning the container relative to the trailer. Some embodiments further include raising the platform underneath the container to a transport height greater than the first height, and lifting the container off of the road by said raising the platform.

Yet other embodiments of the present invention pertain to a method for transporting a container on a road. The embodiment includes providing a pair of containers, each container having a first face that includes an alignment feature and a second face, and a trailer having a U-shape d-platform with an opened end and a closed end and a movable gate capable of closing the opened end. Yet other embodiments include supporting the first container within the U-shape and coupling the alignment feature of the first container to the closed end of the U, supporting the second container within the U-shape, and coupling the alignment feature of the second container to the gate.

Still other embodiments of the present invention pertain to a towable trailer. The embodiment includes a platform supported from the road by a pair of wheels coupled by a corresponding suspension, each suspension being adapted and configured for biasing the platform to a first vertical height for transporting the container over the road or to a second, lower vertical height. Other embodiments further include a first movable gate located about midway along the longitudinal length of one side section, the first gate being adapted and configured to span across at least a portion of the open channel of the U. Yet other embodiments include a second movable gate located at the rear of one side section, the second gate being adapted and configured to span across at least a portion of the open channel of the U.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is excessive and unnecessary.

### BRIEF DESCRIPTION OF THE DRAWINGS

FIG. 1 is a top, rear, and right side perspective view of a trailer according to one embodiment of the present invention.

FIG. 2a is a top, plan view of the trailer of FIG. 1.

FIG. 2b is a left side elevational view of the trailer of FIG. 1.

FIG. 3a is a perspective view of a container according to one embodiment of the present invention.

FIG. 3b is a bottom perspective view of the container of FIG. 3a.

FIG. 3c includes side and end perspective views of an alignment feature according to one embodiment of the present invention.

FIG. 4a shows the trailer of FIG. 1 supporting a single front container.

FIG. 4b is a frontal, left side view of the trailer of FIG. 1 shown supporting front and rear containers.

FIGS. 5a-5h depict the loading of a pair of containers onto a trailer according to one embodiment of the present invention.

FIGS. 6a, 6b, and 6c pictorially represent a trailer according to one embodiment of the present invention being maneuvered by a pickup truck to support a container.

FIGS. 7a and 7b depict the underside of a trailer with a container being placed into the front position.

FIGS. 8a and 8b depict alternate methods and apparatus for maintaining a front container in the front position of the trailer.

FIGS. 9a-9c depict methods and apparatus for supporting a container in the rear location of the trailer.

FIG. 9d is an underside view of the apparatus of FIG. 9c.

FIG. 10a is a perspective view of a portion of a trailer according to another embodiment of the present invention in the transport position.

FIG. 10b shows the apparatus of FIG. 10a in the loading position.

FIG. 11a is a side elevational view of the apparatus of FIG. 10a.

FIG. 11b is a side elevational view of the apparatus of FIG. 10b.

FIG. 12a is a perspective view of a portion of a trailer according to another embodiment of the present invention in the transport position.

FIG. 12b shows the apparatus of FIG. 12a in the loading position.

FIG. 12c is a side elevational view of the apparatus of FIG. 12a.

FIG. 12d is a side elevational view of the apparatus of FIG. 12b.

FIG. 13a is a perspective view of the underside of a trailer according to another embodiment of the present invention.

FIGS. 13b, 13c, and 13d are top perspective views that depict the trailer of FIG. 13a in different loading configurations.

FIG. 14a is a top perspective view of a suspension according to another embodiment of the present invention in the transport position.

FIG. 14b depicts the suspension of FIG. 14a in the loading position.

FIG. 14c is a top plan view of the suspension of FIG. 14a.

FIG. 15a is a top perspective view of a suspension according to another embodiment of the present invention in the transport position.

FIG. 15b depicts the suspension of FIG. 15a in the loading position.

FIG. 15c is a top plan view of the suspension of FIG. 15a.

FIG. 16a is a top perspective view of a suspension according to another embodiment of the present invention in the transport position.

FIG. 16b depicts the suspension of FIG. 16a in the loading position.

FIG. 16c is a top plan view of the suspension of FIG. 16a.

FIG. 17a is a top perspective view of a suspension according to another embodiment of the present invention in the transport position.

FIG. 17b depicts the suspension of FIG. 17a in the loading position.

FIG. 17c is a top plan view of the suspension of FIG. 17a.

FIG. 18a is a perspective representation of a portion of an apparatus according to another embodiment of the present invention.

FIG. 18b shows the apparatus of FIG. 18a in the loading position.

FIG. 18c is a side elevational view of the apparatus of FIG. 18a

FIG. 19 is a top plan view of a pair of trailers shown in a storage configuration.

FIG. 20a is a rear, right side perspective photographic representation of a vehicle incorporating a storage bed according to one embodiment of the present invention.

FIG. 20b shows the apparatus of FIG. 20a with the side extensions pulled inward.

FIG. 20c is a front, right side perspective photographic representation of a vehicle similar to the vehicle of FIG. 20a transporting a container according to another embodiment of the present invention.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that must be included in all embodiments, unless otherwise stated.

The use of an N-series prefix for an element number (NXX.XX) refers to an element that is the same as the non-prefixed element (XX.XX), except as shown and described thereafter. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only. Further, with discussion pertaining to a specific composition of matter, that description is by example only, and does not limit the applicability of other species of that composition, nor does it limit the applicability of other compositions unrelated to the cited composition.

As used herein, the suffixes “L,” R,” “F,” or “Rr,” refer respectively to the left, right, front, or rear of an object. Further, the terms “inboard” and “outboard” refer to placement that is closer to the center or further from the center, respectively.

The present invention pertains to various methods and apparatus for transporting cargo. In one embodiment of the present invention there is a two-wheeled trailer adapted and configured for transporting a standardized container. In some embodiments, the trailer includes a frame that is predominantly U-shaped, with the parallel sides of the “U” shape extending inwardly a sufficient amount to support the underside of the container. In some embodiments, the container includes a plurality of feet for supporting the container on the ground. When such containers are transported within the U-shape, the feet extend downwardly within the open portion of the “U” shape. In some embodiments, the outboard sides of the legs of the container and the inboard open edges of the trailer frame are configured to be close enough to each other that the container legs and the sides of the U-shape coact to longitudinally guide the container as it is placed onto the trailer.

There is an increasing need for a system of providing storage containers, which can hold different types of cargo, transported to a location, and then stored at the location with the cargo still present. Different types of cargo generally refer to the weight of the cargo and the fragility of the cargo. Various embodiments of the present invention relate to a means to provide a system within a network of transporting cargo trailers that can easily transport these different types of cargo.

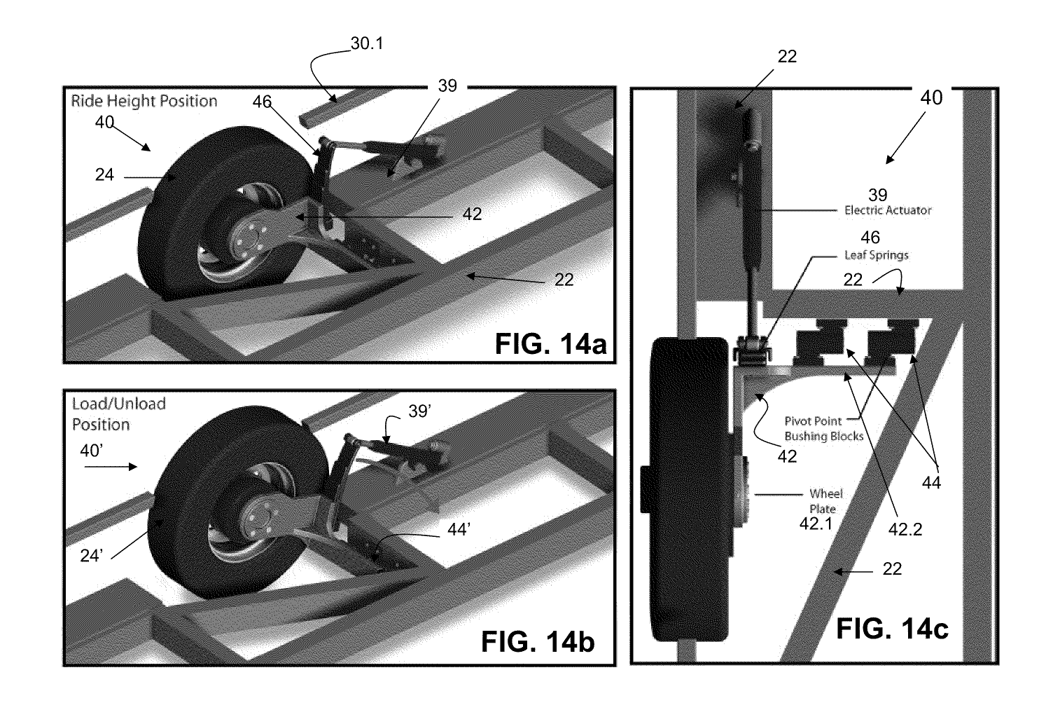

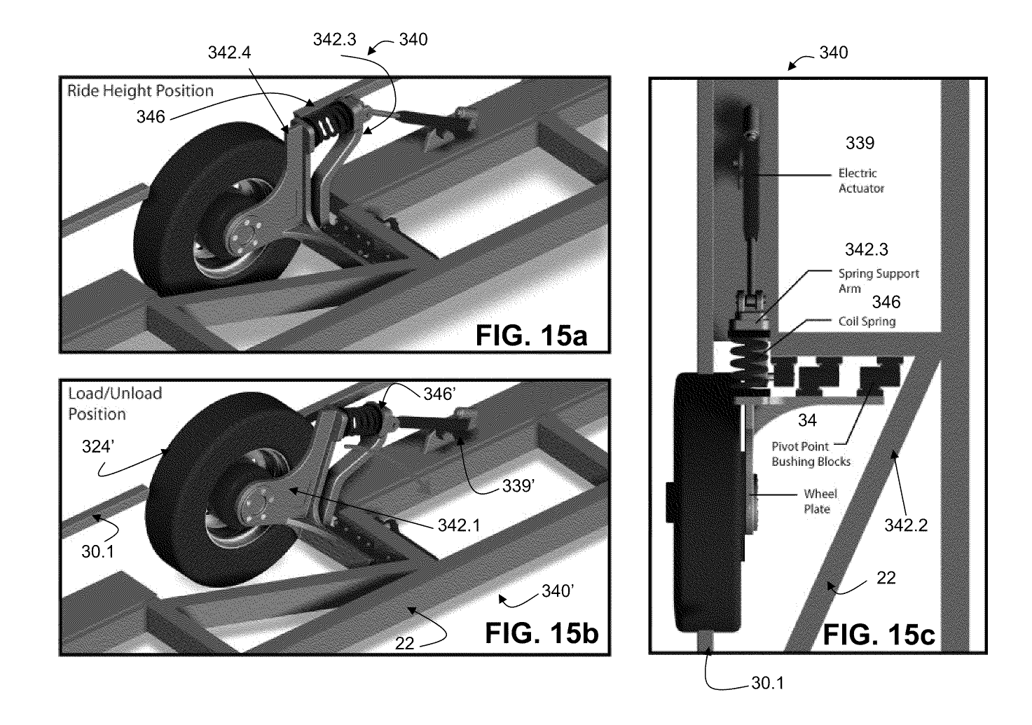

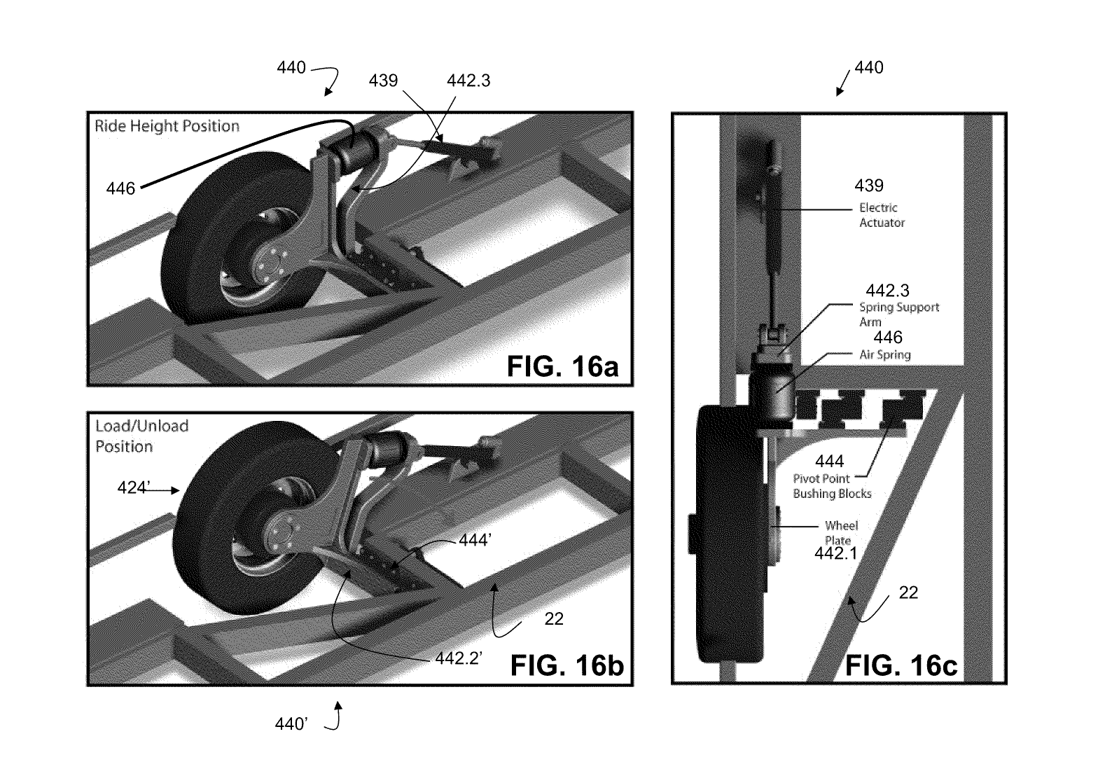

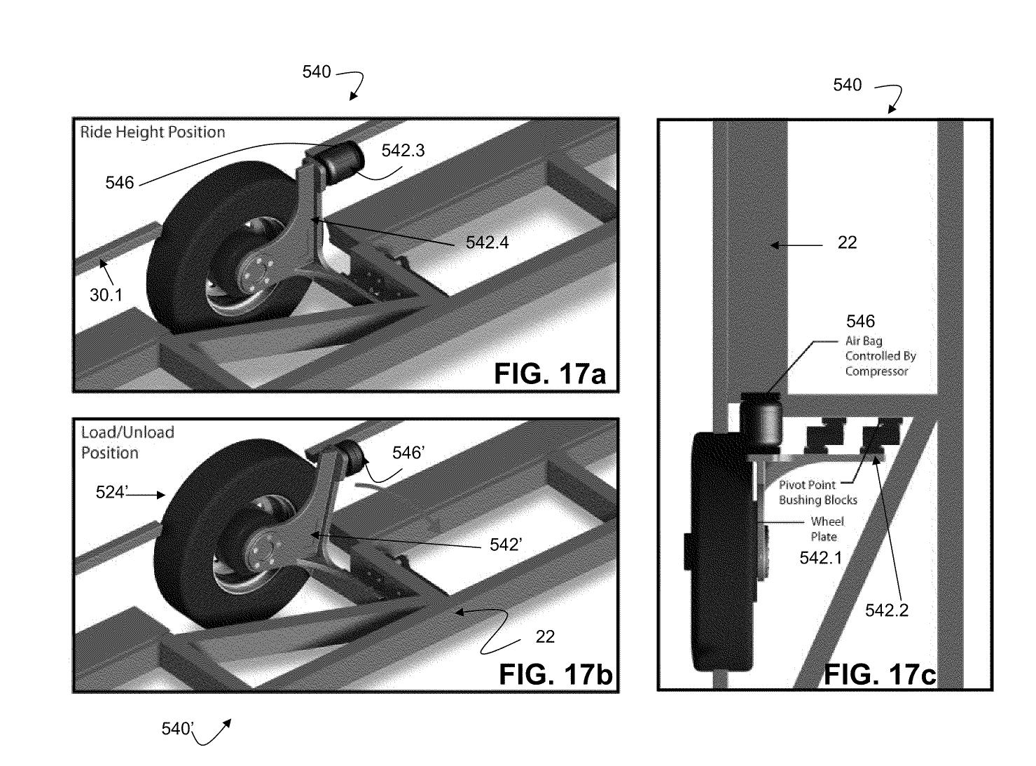

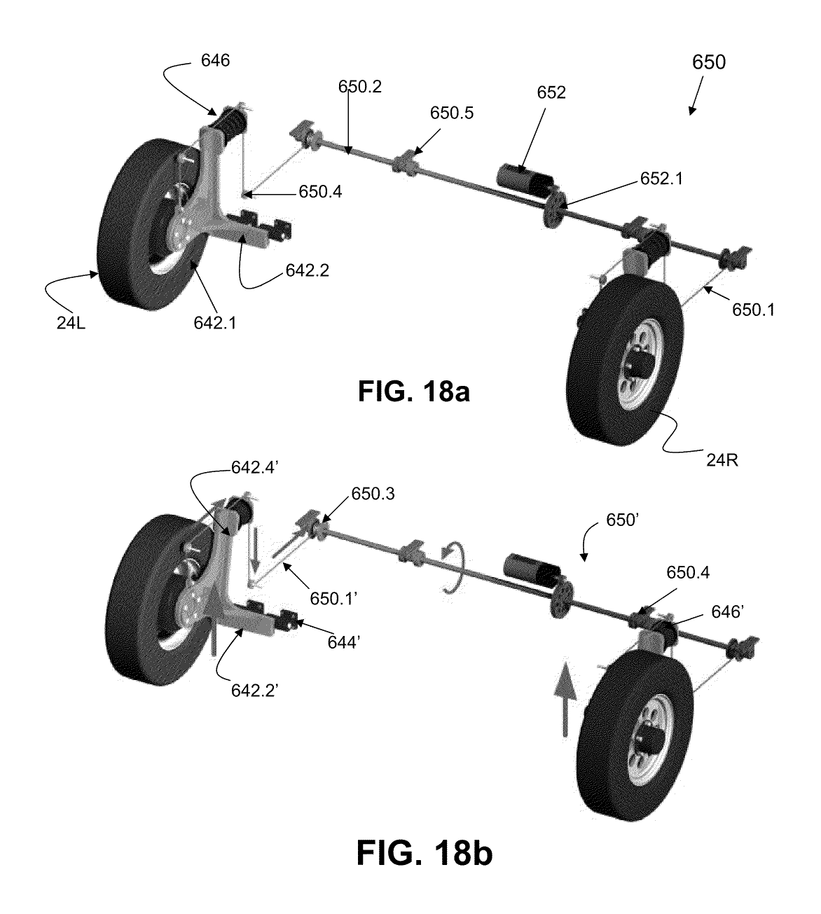

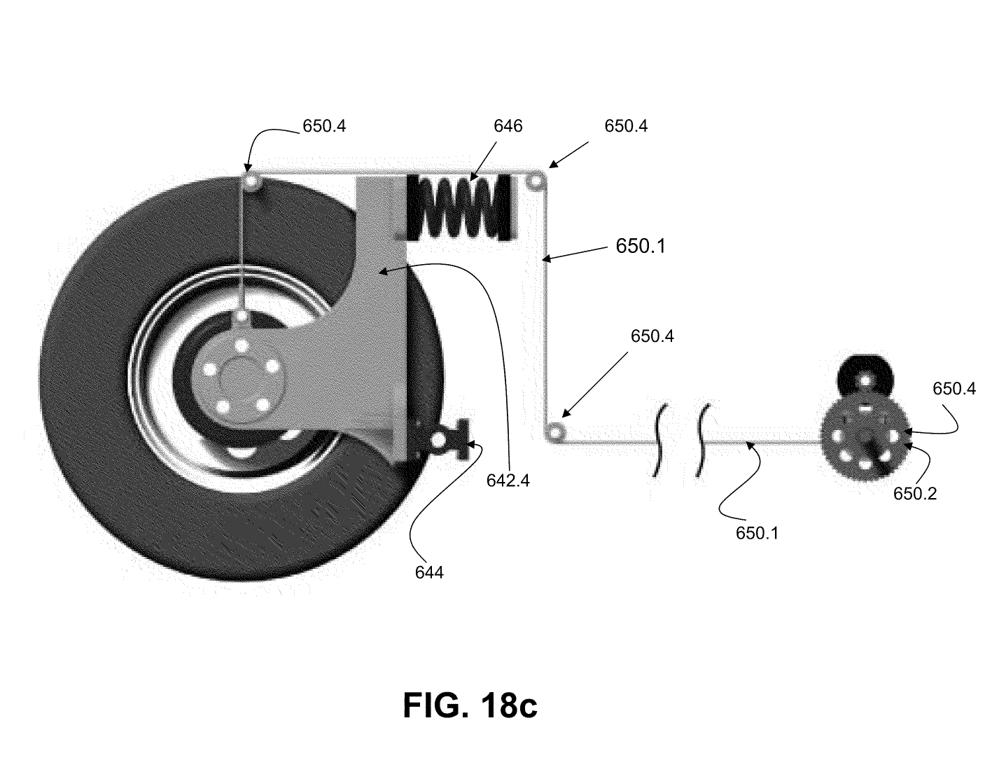

Some embodiments of the present invention include trailer suspensions or vehicle suspensions having configurations that are generally adapted and configured for transporting cargo of a particular type or weight. As some examples, a suspension with an air compressor and air spring suspension (such as that shown in FIG. 17) can be used with fragile cargo. A suspension with a leaf spring suspension (such as that shown in FIG. 14) can be used with low gross weight cargo. A suspension with coil spring suspension (such as that shown in FIG. 15 or 18) can be used with medium gross weight cargo. A suspension with an air spring coupled to an actuator (such as that shown in FIG. 16) can be used with heavy gross weight cargo.

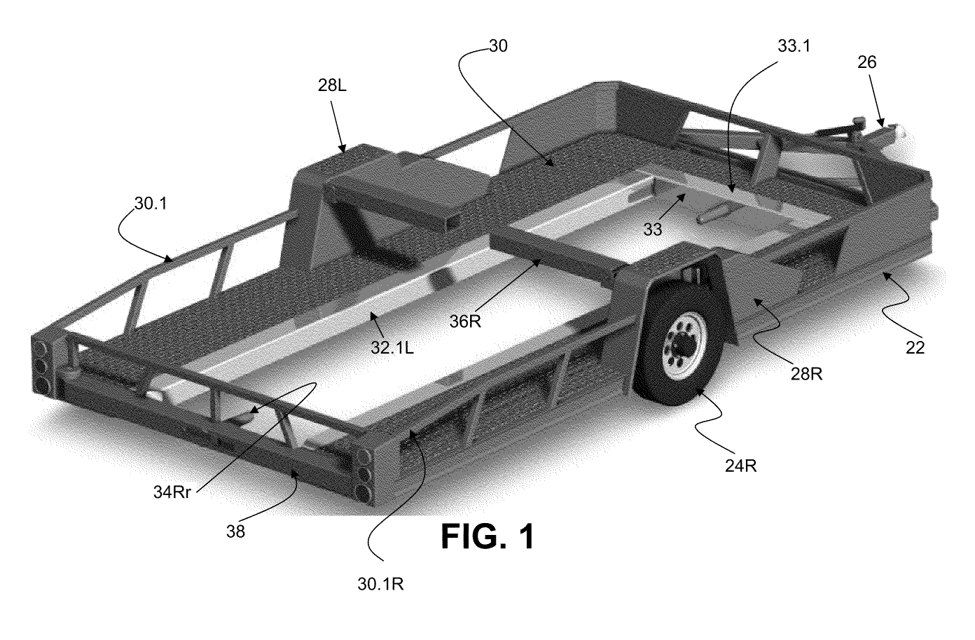

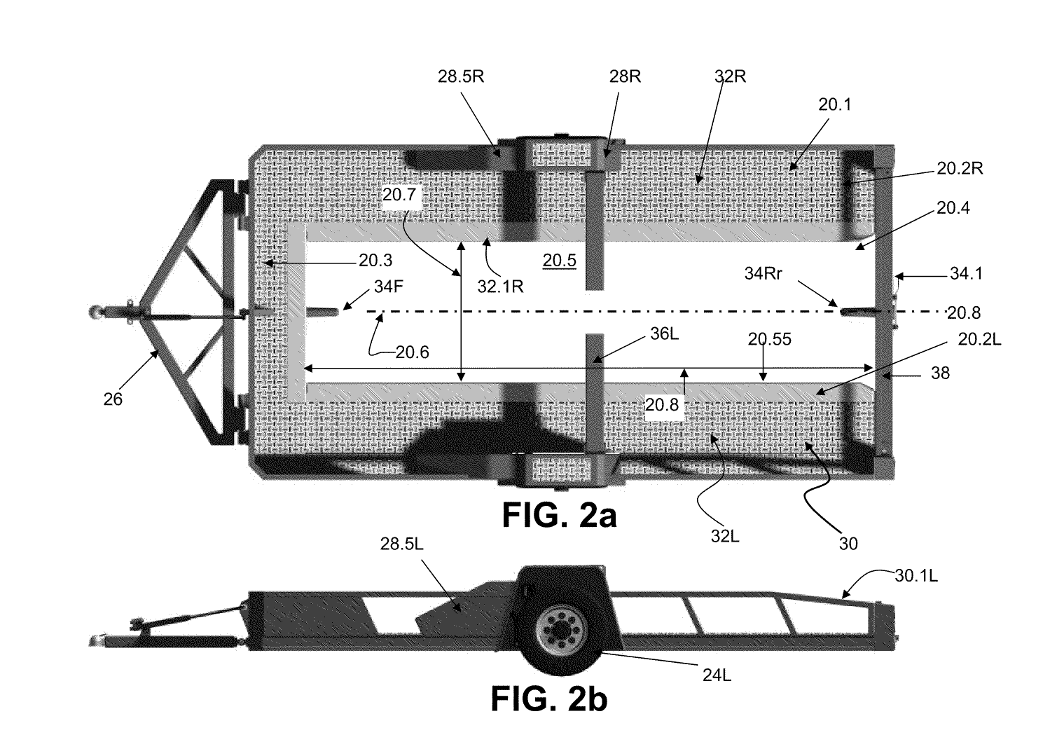

FIGS. 1-2 show various views of a trailer 20 according to one embodiment of the present invention. Trailer 20 includes a generally U-shaped frame 22 supported on either side by a right wheel 24R and a left wheel 24L. A hitch assembly 26 extends from the closed side of the U, and is adapted and configured for towing of trailer 20 by another vehicle, such as a truck or car.

Frame 22 includes a bed or platform 30 that extends around the U-shape. Bed 30 includes inwardly-extending lateral platforms 32R, extending from the right, and 32L, extending from the left. Preferably, the top of bed 30 is generally planar and generally located beneath the rotational axis of wheels 24 (as best seen in FIG. 2). Trailer 20 further includes a protective apron 30.1 that extends around the outermost periphery of the trailer. Apron 30.1 extends vertically upward, and in the front corners includes protected sheet metal, and on the rear corners includes vehicle lights and features for coupling to a rear gate 38.

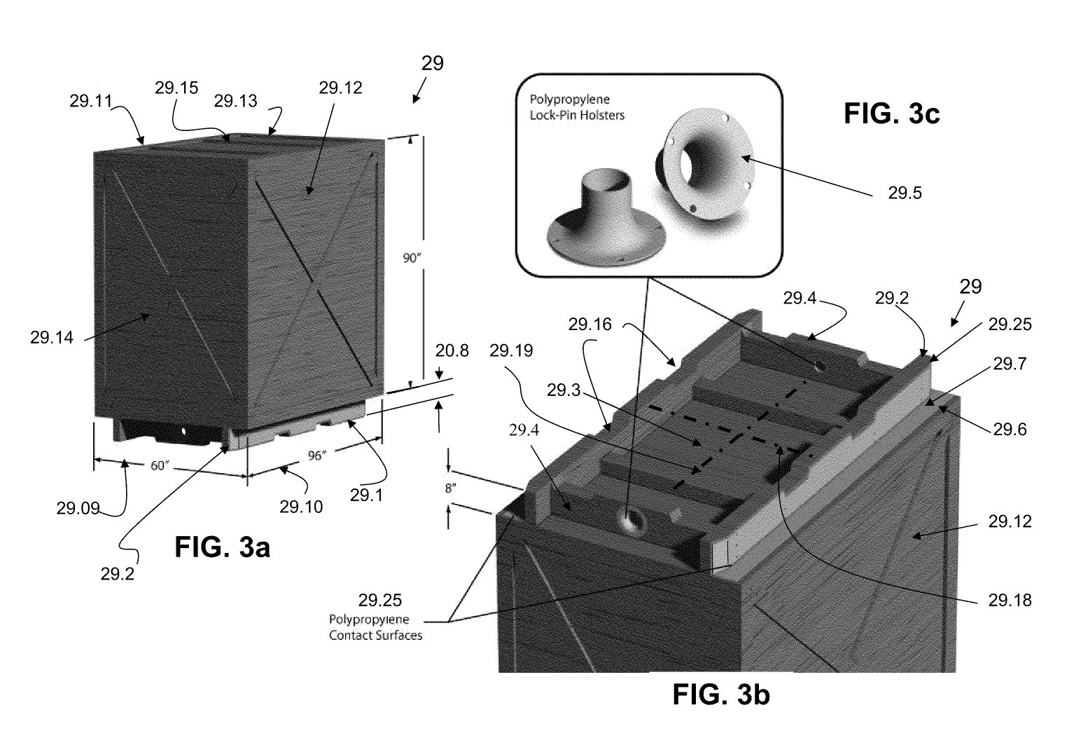

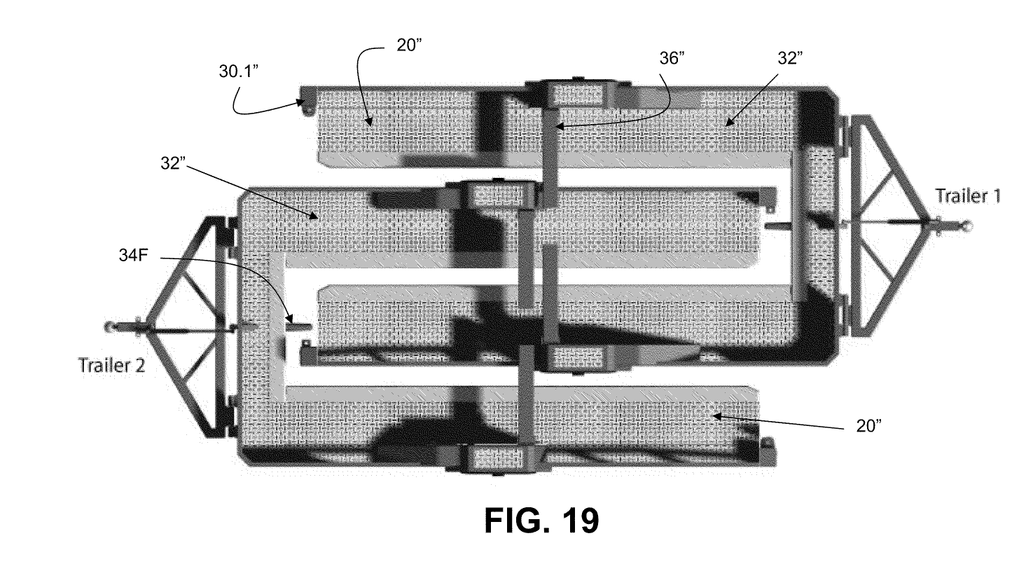

Trailer 20 further includes right and left wheel housings 28R and 28L placed along the outboard edges of bed 30. In one embodiment, right and left intermediate arms 36R and 36L are pivotally coupled to the respective wheel housing, and can be positioned as gates to prevent the sliding movement of a cargo container 29F (as best seen in FIG. 3). Forward extensions of the right and left wheel housings 28.5R and 28.5L provide containment of an electrical actuator 39 (as best seen in FIGS. 14, 15, and 16), and/or portions of a cable controlled kneeling system (as bees seen in FIGS. 18 and 19).

Trailer 20 includes side sections 32R and 32L that comprise opposite sides or arms of the U-shape 20.1. Side sections 32L and 32R are joined at the closed end of the U-shape by a front section 33. An alignment feature 34F protrudes from the aft face of front section 33, and is preferably located along the longitudinal centerline or axis 20.8. However, the present invention contemplates the placement of alignment feature 34F at any vertical or lateral location across the front of trailer 20 that is also suitable for coupling to a complementary alignment feature on a container.

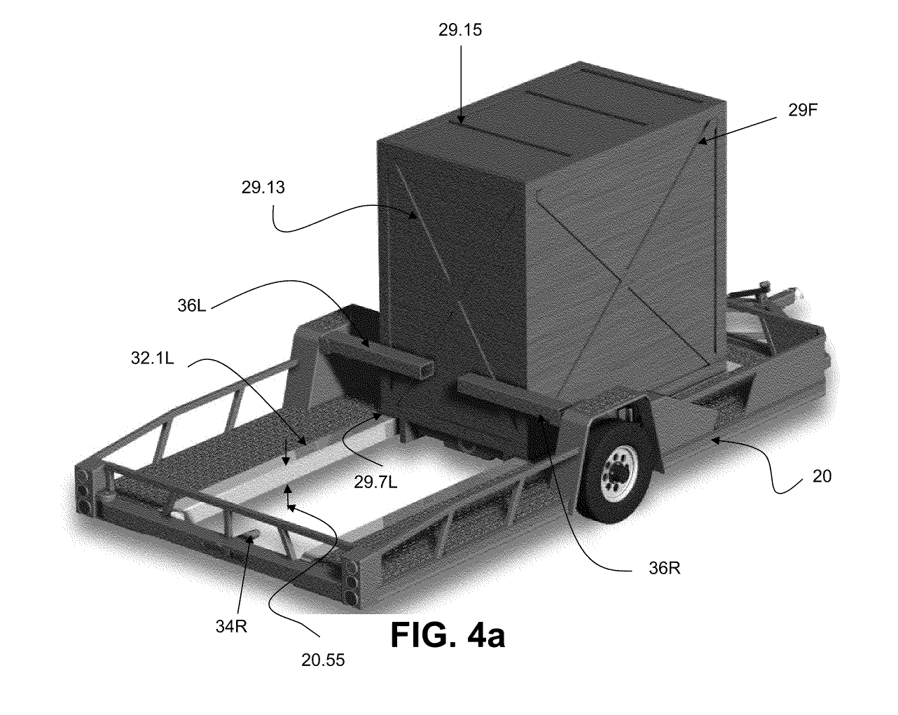

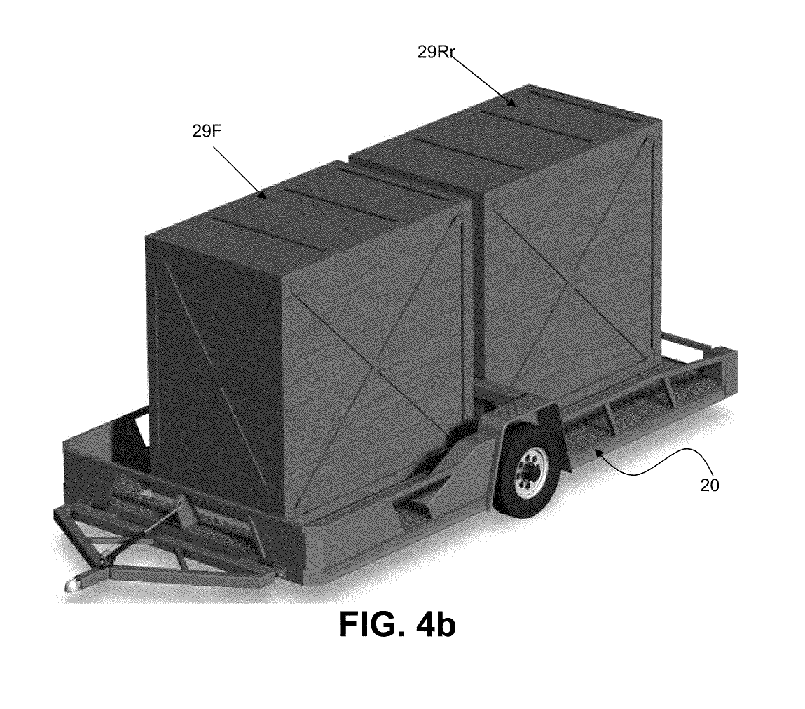

Side sections 32R and 32L combine with front section 33 to create a general U-shape of trailer 20, and define a generally open central portion 20.5 that is centrally located within the U. Referring to FIGS. 1 and 2a, it can be seen that around the three-sided periphery of central portion 20.5 is a generally planar shelf (32.1R, 32.1L, and 33.1) that is adapted and configured for support of the underside of one or more containers. In some embodiments, shelf 33.1 is not intended to provide support to the underside of a container, and such support may be prevented by the shape of the support structure of the container (for instance, such as by the shape shown in FIG. 3b, which shows beveled sections 29.25 extending to the fore and aft peripheries, respectively). In one embodiment, this three-sided shelf is covered by or fabricated from a smooth, hard material, such as stainless steel sheet material, in order to reduce wear and provide sufficient strength to carry the weight of the container and any cargo contained within the interior of the container. Referring briefly to FIG. 4a, each shelf 32.1 has a thickness 20.55. As will be discussed later, the thickness, length, and width of the central portion 20.5 of the U-shape are preferably adapted and configured for mating with a bottom-side support structure of a container.

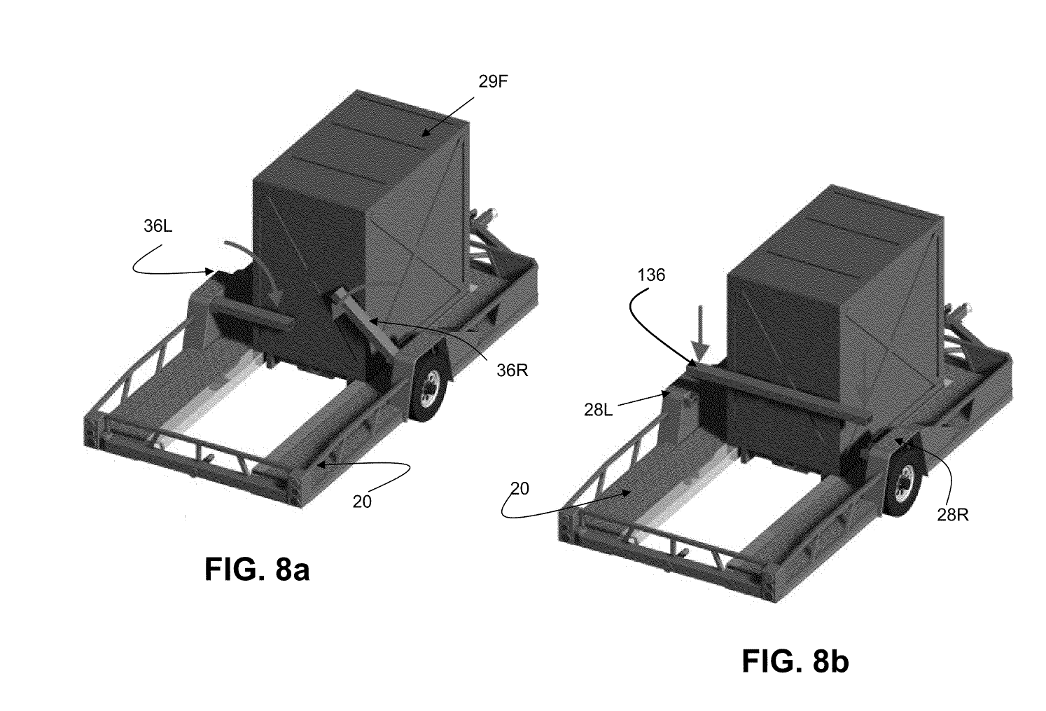

Trailer 20 further includes one or more gates that extend laterally in order to limit the axial or longitudinal movement of a container being supported by the trailer. Referring to FIGS. 1 and 2a, trailer 20 includes a pair of intermediate arms or gates 36L and 36R that extend inwardly from respective wheel housings 28L and 28R, respectively. In one embodiment, an arm 36 is hingedly connected to its corresponding wheel housing and pivotal about a horizontally disposed axis. As can be seen in FIG. 8a each of the arms 36 can be swung upward and away from the central portion of the U. As best seen in FIG. 1, each arm can also be swung to a horizontal position extending across at least a portion of the center 20.5 of trailer 20. The present invention also contemplates embodiments such as that shown in FIG. 8b in which the intermediate gate 136 is a single, separate component that couples on either end to holding brackets mounted on the wheel housings.

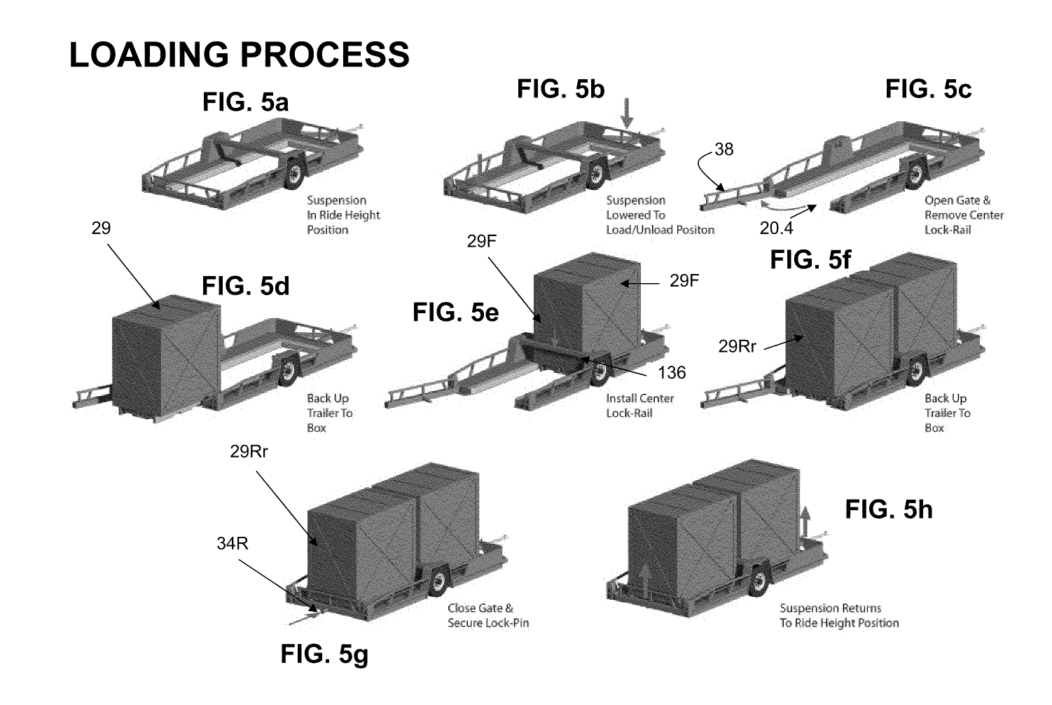

Referring again to FIGS. 1 and 2a, trailer 20 further includes a rear gate 38. Rear gate 38, in one embodiment, is hingedly connected a corner of to the protective apron 30.1L. As best seen in FIGS. 5c and 5g, gate 38 is pivotal about its vertical hinge axis, and can be swung rearward and away from the interior of the U-shape so as to provide unobstructed entry of a container into the U-shape. Gate 38 can subsequently be swung shut across the open end 20.4 of the U, and coupled with a locking device to the opposite apron 30.1R. The present invention further contemplates other types of rear gates, including those that are hingable about a horizontal axis (such as gate 36), and further contemplates rear gates that are separate components that can be coupled to holding brackets mounted to either side sections, and put in place either vertically from a position above the rear corners of apron 30.1 or horizontally from a rearward position onto the corners of apron 30.1

Rear gate 38 preferably includes an alignment feature 34Rr to provide lateral alignment of a container placed near the opened end 20.4 of the U-shape of trailer 20. In one embodiment, alignment feature 34Rr is identical to alignment feature 34F, as best seen in FIG. 2a. In some embodiments, alignment feature 34Rr is a tapered pin that includes a threaded outer diameter (not shown) that engages a threaded inner diameter of rear gate 38. A lever arm 34.1 is attached to alignment feature 34Rr, and includes a handle for grasping by the user of trailer 20. As arm 34.1 is rotated, alignment feature 34Rr also rotates, and is advanced in a forward direction so as to mate with a complementary alignment feature located on a container. The present invention contemplates any type of complementary-shaped alignment features that can establish the lateral position of the container within the U-shape, also provides for adequate overlap of the container ledge with the trailer shelf.

FIGS. 3a and 3b show top, frontal perspective and bottom side views, respectively, of a container 29 according to one embodiment of the present invention. Preferably, container 29 is a six sided box that defines an interior suitable for carrying cargo. Container 20 includes a top 29.11, lateral sides 29.12, a rear 29.13, and a front 29.14. Container 29 includes at least one door (not shown) for accessing the interior, and can be constructed from any type of material. Referring to FIG. 3a, in one embodiment container 29 has an outermost width of about 60 inches, and outermost length of about 96 inches, and a height (not including the support structure) of about 90 inches. However, these dimensions are by example only and are not to be construed as limiting.

As best seen in FIG. 3b, the bottom 29.3 of container 29 includes a downwardly-extending support structure 29.1 that includes a pair of longitudinally disposed legs or side rails 29.2. Each of these legs 29.2 extends downwardly a distance 20.8 from the bottom 29.3 of container 29. In one embodiment, the downward extent of the leg is about eight inches, and for such a container the top surface of a side section 32′ in the kneeled position would be less than eight inches so that it can slide under the bottom-facing ledge 29.7. Preferably, the outermost corners, front and rear, include a beveled surface 29.25 that is preferably coated in a smooth, sufficiently hard, low-friction material such as polypropylene. These chamfered corners provide lateral alignment of container 29 as it is slid into the U-shape of trailer 20.

As best seen in FIG. 3b, each side rail 29.2 is recessed inwardly from the side periphery 29.6 of container 29. This recess establishes a ledge 29.7 that extends fore and aft along the bottom 29.3. This ledge is adapted and configured to bear the weight of container 29 and its cargo as ledge 29.7 is supported by shelves 32.1 of trailer 20. Therefore, the weight of container 29 and its cargo can be supported either by ledges 29.7 of bottom 29.3 (when supported within the U of trailer 20) or by the bottom-most face of side rails 29.2 (for example, when container 29 is resting on the ground).

Still referring to FIGS. 3a and 3b, support structure 29.1 further includes front and rear members 29.4 that extend laterally between side rails 29.2. Preferably, each member 29.4 is recessed inward from the periphery of the corresponding front and rear faces 29.14 and 29.13, respectively, of container 29. In one embodiment, the beveled ends 29.25 of side rails 29.2 extend to the periphery of faces 29.14 and 29.13, thus preventing the recessed area in front of members 29.4 from serving as a support ledge capable of being supported by shelf 33.1 of trailer 20. However, the present invention also contemplates those embodiments in which the support ledge of container 29 extends around all four edges of the periphery of container 29.

Front and rear members 29. 4 each include an alignment feature 29.5 that is adapted and configured to couple with a corresponding alignment feature 34 of trailer 20. As shown in FIG. 3c, alignment feature 29.5 can be a receptacle or hole that has an innermost diameter larger than the outermost diameter of pin 34. In one embodiment, coupling feature 29.5 can be defined within a polypropylene holster that includes a radiused inlet for assisting in lateral deflection as the conical pin 34 is inserted during alignment. Preferably, the alignment feature of the container 29 is complementary in shape to the alignment feature of the trailer. However, it is not necessary for the features to be complementary in shape.

The alignment features 29.5 and 34 are adapted and configured to provide an approximate lateral centering of container 29 within the U-shape 20.1, so as to provide proper overlapping contact between ledge 29.7 and shelf 32.1. It is also appreciated that the beveled front corners 29.25 provide a degree of longitudinal alignment of container 29 within the U-shape. The present invention contemplates any manner of interfacing container 29 with trailer 20 to provide proper support of the cargo and container load, including co-action between features 29.5 and 34, and/or co-action of side rails 29.2 and side sections 32.

FIGS. 3a and 3b also show features that permit stable stacking of one container upon another. The top 29.11 of container 29 includes a pair of top rails 29.15 that extend laterally across the top face. These rails 29.5 are separated by a distance that is complementary to the separation between a pair of cutouts 29.16 on the bottom side rails 29.1. Therefore, the support structure 29.2 of a container can be fit upon the top 29.11 of an adjacent container by locating the top rails 29.15 of the adjacent container within the cutouts 29.16 of the top container.

In some embodiments of the present invention, the support structure 29.2 of container 29 is symmetrical about a longitudinal centerline 29.19, and further about a lateral centerline 29.18 of container 29. With such two-dimensional symmetry, container 29 does not have a different right or left feature, nor does it have different fore and aft features. This provides ease of use to the user, who can present the container to the kneeled trailer in at least two different orientations. However, the present invention also contemplates those embodiments in which container 29 is not symmetrical about a lateral axis 29.18, such as those embodiments in which there is a single alignment feature 29.5. In those embodiments, a front container loaded onto a trailer should have the alignment feature presented to the front alignment feature 34F of trailer 20, and the rear container should have its alignment feature 29.5 presented to the rear alignment feature 34Rr.

FIGS. 4a and 4b show containers that are loaded onto a trailer. Referring first to FIG. 4a, it can be seen that a front container 29F has been placed into the U-shape of trailer 20. It can be seen that the open lateral width 20.7 of the U-shape is greater than the distance between the outermost faces of side rails 29.2 of container 29. Therefore, support structure 29.1 fits in its entirety within the open portion of the U. The side ledges 29.7 of container 29 are in contact with and supported by the shelves 32.1 of side sections 32, since the lateral periphery of container 29 is wider than the open, lateral width 20.7. Further, it can be seen in FIG. 4a that the vertical height 20.8 (as seen in FIG. 3a) of side rail 29.2 is greater than the thickness 20.55 of platform 32.1. Therefore, the bottom surfaces of side rail 29.2 extend below the bottom surface of side rails 32, this additional downward extension of side rails 29.2 representing the vertical clearance for sliding of side sections 32 underneath a container being supported by the roadway. Further, it can be seen that the length 29.10 of container 29 is less than about half of the length 20.6 of trailer 20, and further is less than the distance from the rearward face of front section 33 to the forward face of the midsection arms 36L and 36R. Further, pin 34F has been received within receptacle 29F (not shown).

FIG. 4b shows a second container 29Rr placed on trailer 20. Containers 29F and 29Rr are identical, and therefore the support structure of container 29Rr likewise fits inbetween the inward faces of side sections 32 and extends below the bottom surface of side sections 32. Container 29Rr is placed immediately behind arms 36. The aft facing receptacle 29F of container 29Rr has received within it alignment pin 34R of rear gate 38 (not shown).

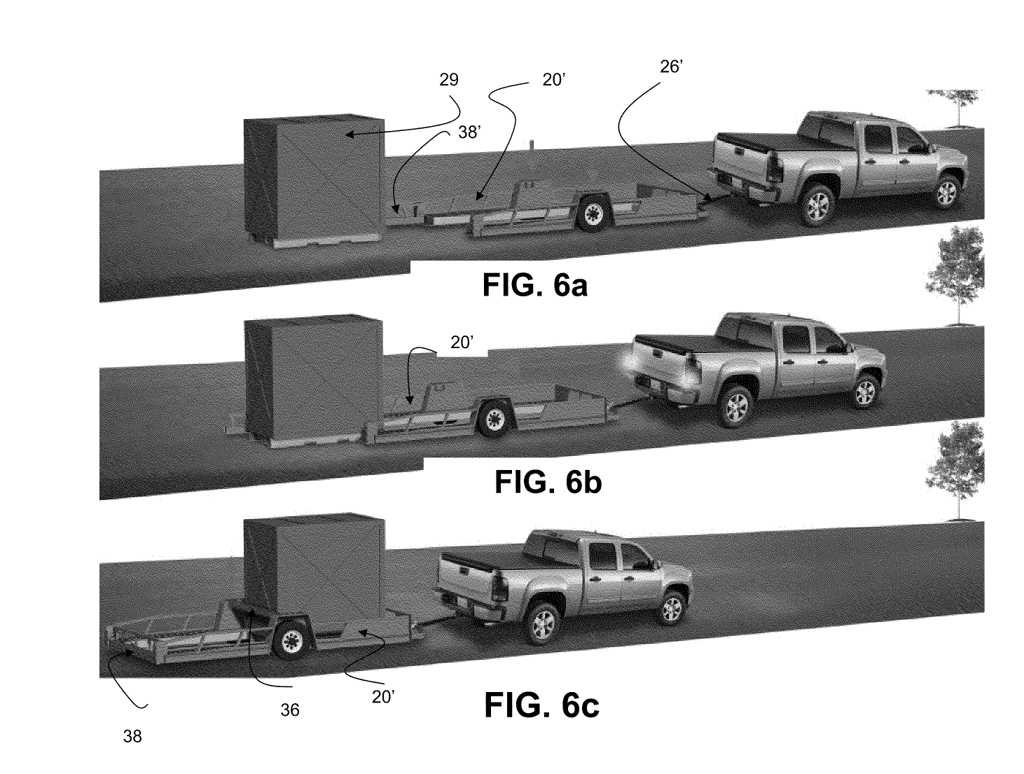

FIGS. 5 and 6 depict various aspects of the loading of a container 29 onto a trailer 20. In one embodiment, the trailer is lowered to a load/unload position. The rear gate 38 is opened, and the trailer can be backed up underneath the container 29. The legs 29.2 of the container support the outward bottom sides of the container 29 at a height that is above the height of the top surface of the lateral platforms when the trailer is in the load/unload position. The trailer can be backed up such that a front container 29F is moved to the enclosed portion of the U-shape. Once container 29F is located at the front of the trailer, the intermediate arms 26 are swung down to retain the container in that position, and the trailer and then be further backed up to load a second rear container 29R behind the arms 36. The gate 38 is closed when the second container is loaded, and a rear pin 34R is inserted to couple the rear container to gate 38. After the second container is loaded, trailer 20 can be restored to the ride height position, and the two containers can then be transported. As an alternative to the pivoting intermediate arms 36, a single cross member 136 can be supported by the wheel housings to maintain container 29F into forward position, as best seen in FIG. 8b.

FIG. 5a shows trailer 20 with its suspension system being set to a ride height or transport position. In this configuration, the underside of the trailer is located a sufficient distance from the roadway to permit travel over uneven surfaces. In FIG. 5b, the suspension system for each wheel has been lowered to place trailer 20 into its loading position 20′. In this position the bottom surface of trailer 20 preferably does not touch the roadway and the top surface of shelf 32.1 is at a vertical distance above the road that is less than the height 20.8 of a container (this height being nominally about eight inches in some embodiments). FIG. 5c shows gate 38 opened and swung away from the opened end 20.4 of trailer 20.

FIG. 5d shows trailer 20 being backed up toward a prepositioned container 29F supported on the roadway such that side sections 32 slide underneath ledges 29.7 of container 29. FIG. 5e shows container 29F being in its full forward position, with alignment features 29.5 and 34F being coupled together to assist in laterally locating the container within the U-shape. Gate 136 is shown spanning the U-shape behind container 29F. FIG. 5f shows a second container 29Rr that has been located into the aft portion of the U-shape, behind arm 136 by pushing the trailer of FIG. 5e backward onto the prepositioned container 29Rr. Preferably, the movement of trailer 20 during the operations depicted in FIGS. 5d and 5f are performed with the hitch 26 coupled to a vehicle (not shown).

FIG. 5g shows gate 38 swung to the closed position and spanning across the opened end of the U. Alignment feature 34R is roughly aligned with alignment feature 29.5 of container 29Rr. The two alignment features 29.5 and 34R are coupled together. Since the weight of container 29Rr is supported by the roadway, the coupling of the two alignment features results in lateral motion of trailer 20 relative to container 29Rr. FIG. 5h shows full coupling of these alignment features, and the suspension system of each wheel is returned to the ride height or transport position.

FIGS. 6a, 6b, and 6c show a comparable placement of a container 29 onto a kneeling trailer 20′. In these figures trailer 20 is hitched to a vehicle, the hitch being canted upward in its kneeling position 26′. FIG. 6b shows the vehicle pushing on the hitch and sliding trailer 20′ underneath the ledges of container 29. In FIG. 6c, the container has been fully loaded, gates 38 and 36 placed in their transport positions, and trailer 20′ can now be brought to its transport position for towing.

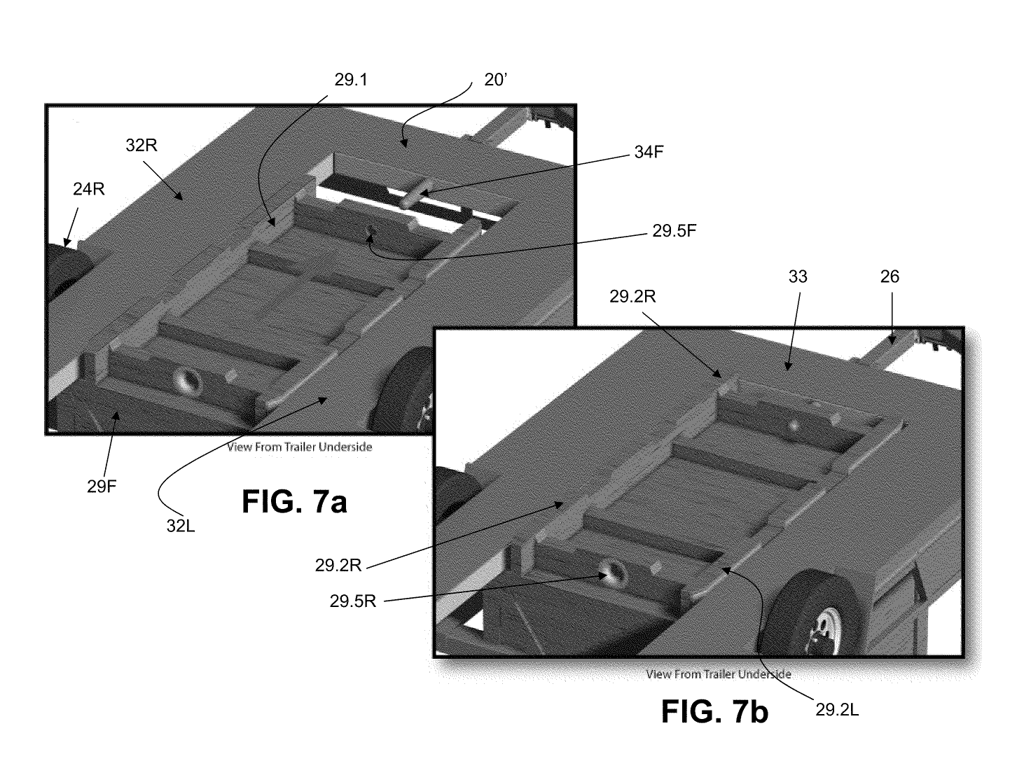

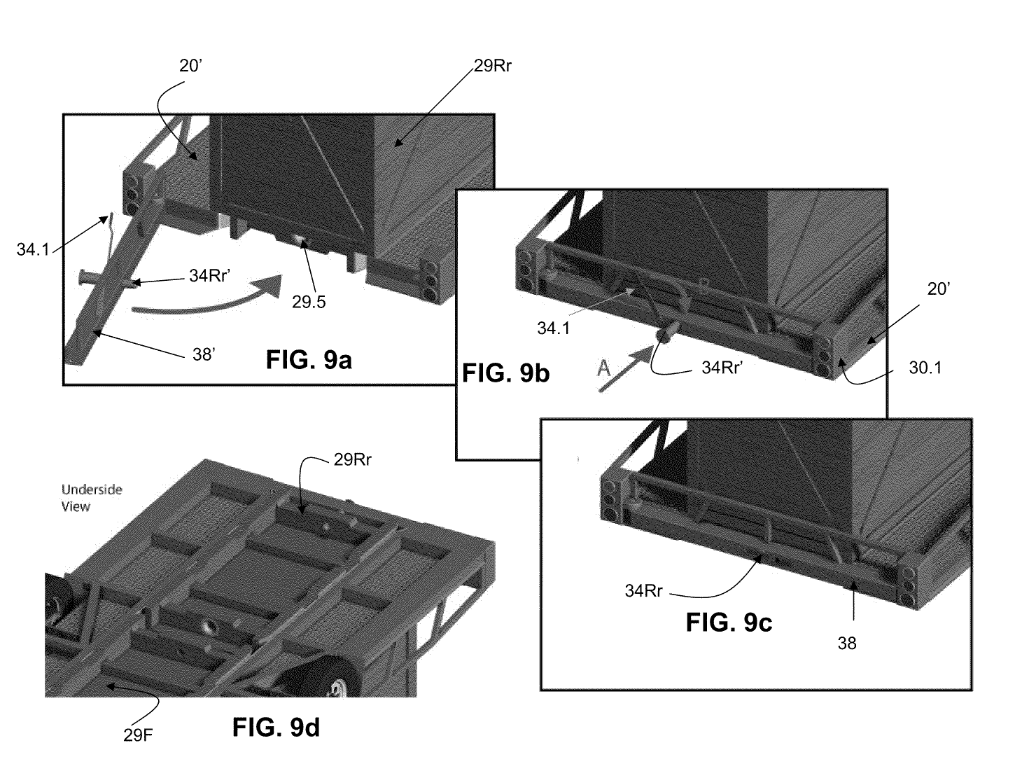

FIGS. 7 and 9, depict various aspects of the coupling of a container 29 to trailer 20. Preferably, each container 29 includes front and rear receptacles 29F that are adapted and configured to couple with the corresponding pin 34. As best seen in FIG. 7a, forward receptacle 29.5 receives within it pin 34F when container 29F is moved toward the front of trailer 20. For a front container, the rear receptacle 29.5R is not used. However, referring to FIG. 9, the rear receptacle 29.5R of the rear container 29R couples to rear pin 34R so as to couple rear container 29R to gate 38.

Referring to FIG. 7a, it can be seen that a container 29F is located near the front portion of the U-shape 20.1, but is not yet in its fully forward position. The underside of the support structure 29.1 can be seen nested within the central portion 20.5 of U-shape 20.1. There is clearance between the laterally outermost faces of support structure 29.1 and the inward faces of side sections 32R and 32L, such that there is little or no resistance to sliding the trailer 20′ relative to container 29F. Trailer 20′ is supported from the roadway in the kneeling position by wheels 24R and 24L.

FIG. 7b shows container 29F nested in the fully forward position within the U-shape. Alignment features 34F and 29.5F are fully coupled. During the coupling, it may be appropriate for the user to laterally reposition trailer 20′ or container 29F. FIGS. 9a, 9b, 9c, and 9d depict various aspects of the loading of a rear container onto the trailer. FIG. 9a shows a container 29Rr placed within the aftmost portion of the center portion 20.5 of a trailer 20′. Alignment pin 34Rr has not coupled with its complementary alignment feature 29.5. It can be seen that the downward facing ledges 29.7 of container 29Rr are located directly above portions of the corresponding shelves 32.1 of arms 32.

FIG. 9b shows gate 38 swung shut and appropriately coupled to a corner of apron 30.1. Alignment feature 34Rr is not yet fully coupled with its complementary coupling feature on container 29Rr. In some embodiments, pin 34 is a sliding pin that is slid away from the container during unloading, and slid into the receptacle 29.5 prior to transport. As the pin slides in, the pin's conical shape coact with the receptacle to apply a sideways load onto the container support structure. The handle and arm 34.1 can be coupled to a bracket on the trailer rear gate 38 to lock the pin in the installed position.

In yet another embodiment, the user of the trailer grabs the handle 34.1 and rotates tapered pin 34Rr. As the pin is rotated, a mechanism internal to gate 38 (such as threads, a sliding cam, or the like; and possibly including a ratcheting mechanism to assist making in multiple revolutions of the pin with less than complete revolutions by the arm 34.1) moves pin 34Rr in an axial direction and toward receptacle 29.5. As can be seen in FIG. 9c, pin 34Rr is fully coupled within receptacle 29.5 (as best seen in FIG. 9d), as trailer 20′ can now be brought to its transport position for movement over a roadway.

FIGS. 8a and 8b depict placement of the gate arms 36 behind a front container 29F. FIG. 8a shows right and left arms 36R and 36L, respectively, swinging from upward, loading positions to downward, load-restraining positions. FIG. 8b shows an alternative arm 136 that is a separate component and repeatedly removable from the trailer. Gate 136 is removed and set aside for placement of the front container. After the front container is loaded, gate 136 is placed in a horizontal position and vertically lowered into a pair of opposite support brackets that couple the ends of the respective right and left arms of gate 136 to wheel housings 28R and 28L, respectively.

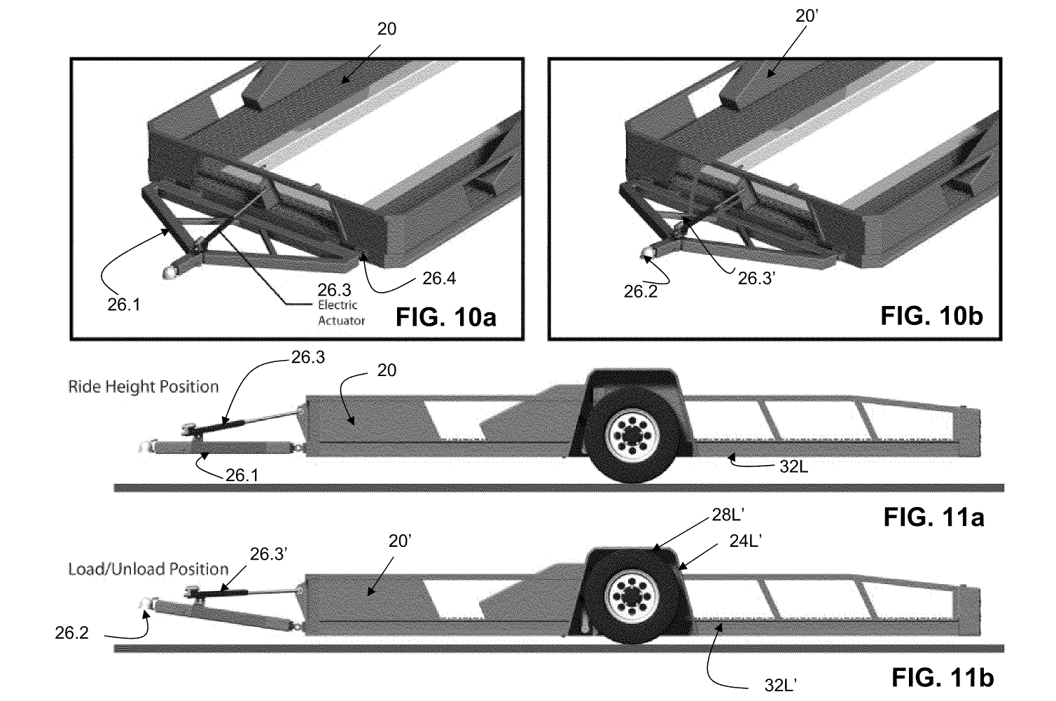

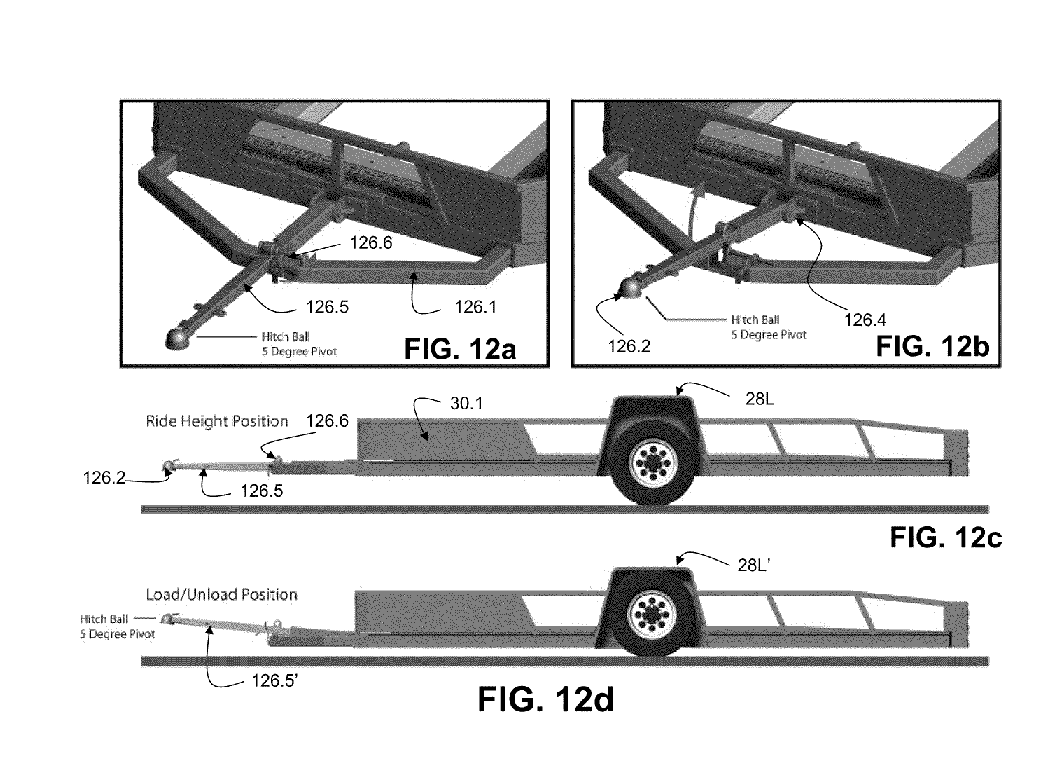

FIGS. 10, 11, and 12 depict alternate hitching systems 26. FIGS. 10 and 11 show an electrically actuated hitching system 26, and FIG. 12 show a manually actuated hitching system 126.

FIGS. 10a and 11a show perspective and side views, respectively, of a trailer 20 in the ride height or transport position. A hitch assembly 26 is likewise in a transport position, such that ball coupling 26.2 is at a proper height for accepting a ball mounted on the rear of a vehicle. Hitch assembly 26 includes a structural towing arm 26.1 that is coupled by hinges 26.4 to front section 33 of trailer 20. Further, an electric actuator 26.3 is further hingedly connected at one end to a portion of the front of apron 30.1, and hingedly connected at the other end to the front of arm 26.1.

FIGS. 10b and 11b show the apparatus of FIGS. 10a and 11a in the kneeled or loading position (and indicated by the use of a singe quote as a suffix). Actuator 26.3′ has reduced the distance between its ends (such as by an internal ball screw arrangement), such that ball coupling 26.2 is high enough to maintain coupling with the ball of the vehicle. Preferably, the location in space of ball coupling 26.2 is about the same in both FIGS. 11a and 11b. However, it can be seen in FIG. 11b that arm 26.1′ is canted upward, since the suspension of the trailer has been brought to the kneeling position. A comparison of the wheels and wheel housings of FIGS. 11a and 11b further show that in the kneeled position the top of the wheel housing 28L′ still provides clearance for rotation of wheel 24L located therein. FIG. 11a shows that in the transport position, the clearance from the top of wheel 24L to the underside of wheel housing 28L is increased to allow for jounce of wheel 24L. Further, as will be seen from discussion of the trailer suspension system, the wheel housing 28 further includes sufficient forward clearance (between the front of the wheel and the inner, aft facing forward portion of the wheel housing) to accommodate a wheel in the kneeled position that has been pitched upward and forward (rotating about its pivot axis).

FIG. 12 depict a hitch assembly 126 according to another embodiment of the present invention. FIGS. 12a and 12c show a trailer with a hitch assembly 126 at the ride height or transport position. FIGS. 12b and 12d show the same trailer at the load and unload positions. Hitch assembly 126 includes a hitch arm 126.1 that extends generally laterally across the front section 33 of trailer 20. Arm 126.1 is rigidly coupled to trailer 20. A second, longitudinally disposed arm 126.5 is coupled by a pin to lateral arm 126.1, and coupled by a second hinge 126.4 to the front of trailer 20. Further, in the transport position, a locking pin assembly 126.6 couples the midsection of arm 126.5 to the forwardmost portion of arm 126.1. When the locking pin is pulled laterally outward from the bushing of arm 126.5, arm 126.5 is thereby able to pivot about hinge 126.4 as best seen in FIGS. 12b and 12d. In some embodiments, the coupling of arm 126.5 and 126.1 can occur at several different positions, such that the vertical height of ball coupling 126.2 can be adjusted for different heights of the towing vehicle.

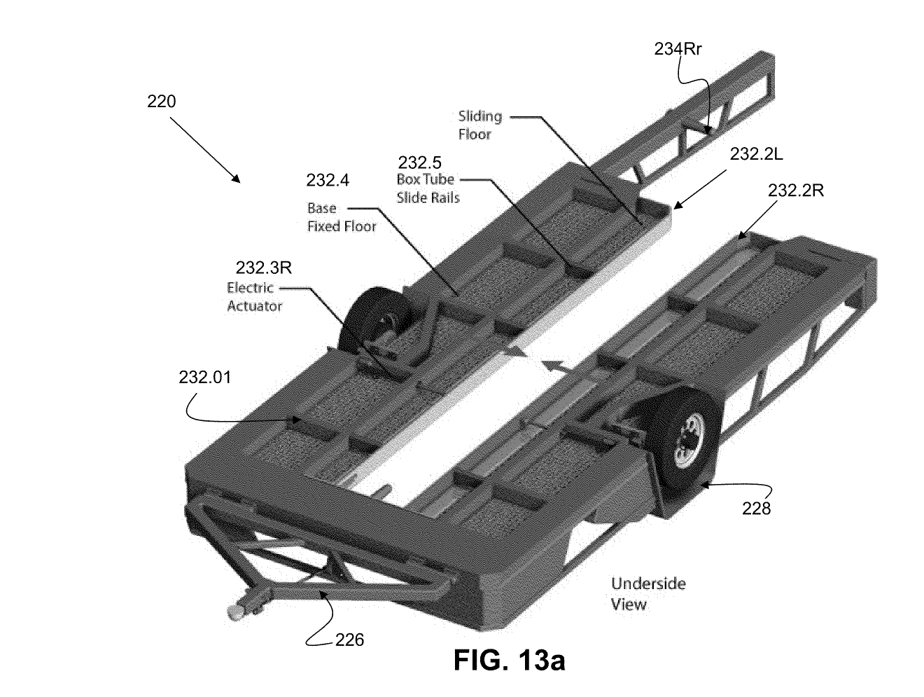

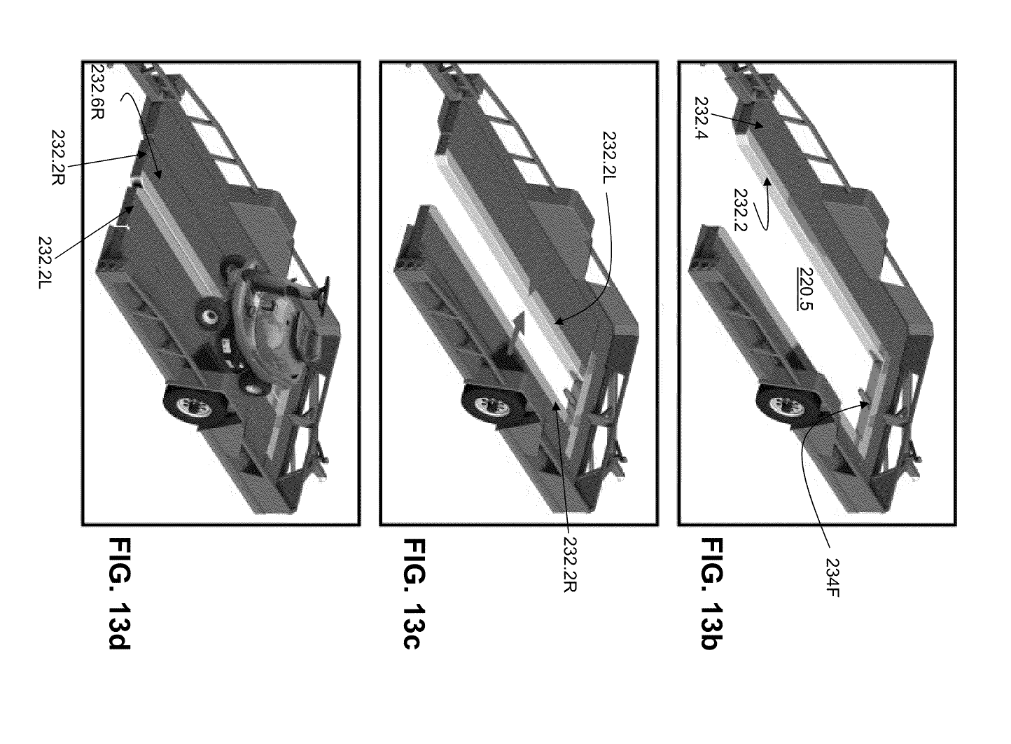

FIG. 13 show a trailer 220 according to another embodiment of the present invention. Trailer 220 includes extension panels 233R and 233L that move inwardly from the corresponding lateral platform 232R so as to further fill the gap of the U-shape. FIG. 13d shows a trailer 220 in which the extensions have been moved inwardly so as to support cargo other than a container 29.

FIG. 13a presents an underside view of a trailer 220 according to another embodiment of the present invention. Trailer 220 is similar to trailer 20, except that trailer 220 includes sliding extensions 232.2 that substantially close the opened central portion 20.5 of trailer 20. Each side section 232 includes nested within it a slidable section 232.2. Section 232.2 can be nested completely within static side section 232, as shown in FIG. 13b so as to maintain a generally open section 220.5. However, each sliding section 232.2L and 232.2R, as shown in FIG. 13c, can be pulled inwardly to span most or all of the central portion 220.5. The front of each sliding section 232.2 preferably includes a recessed portion near front section 233 that can accommodate therebetween projecting pin 234. Likewise, the aft, inner edges of the sliding panels can be adapted to accept therein aft alignment pin 234Rr (as best seen in FIG. 13d). When panels 232.2R and 232.2L are at their inwardmost position, a narrower cargo can be conveyed on trailer 220.

FIG. 13a shows the underside of trailer 220. Side sections 232 are comprised of a plurality of laterally extending box tubes 232.01 that each slidably accepts within them a smaller box tube 232.5. A fixed floor 232.4 is attached to the larger box tubes 232.01. A sliding floor 232.6 is attached to sliding box tubes 232.5, and provides a floor for the narrower cargo. In some embodiments, an electric actuator 232.3R and 232.3L are coupled at one end to side section 232 and at the other end to sliding section 232.2. Extension of the actuators 232.3 result in sliding motion of extensions 32.2 relative to side sections 232.

FIGS. 14, 15, 16, and 17 show various embodiments of a suspension system. FIGS. 14 show a leaf spring 46 that biases a support arm 42. The biased position of the supported wheel can be established by a linear electric actuator 39.

FIGS. 14a, 14b, and 14c shows a suspension assembly 40 according to one embodiment of the present invention. FIGS. 14a and 14b show a side and rear perspective view of the suspension, with the floor of trailer 20 and the wheel housing 28 being removed for the sake of clarity. Suspension 40 includes a wheel 24 bearingly supported by the wheel plate 42.1 of a trailing arm 42. As best seen in FIG. 14c, wheel plate 42.1 extends forward and is rigidly coupled to a frameplate 42.2. A pair of pivoting bushing blocks 44 couple frameplate 42.2 to a lateral member of frame 22. Wheel 24 is able to pitch up and down about a pivot axis established by pivots 44. A spring 46 applies a biasing force between one end of the actuator (the other end of the actuator providing the biasing load to the frame) and support arm 42, such that the support arm and attached wheel bias the trailer to a position above the roadway. It is understood that the attachment of suspension arm 42 to frame 22 can be by any type of connection that permits up and down pitching motion of wheel 24 about the horizontal pitching axis.

FIG. 14 also show an electric actuator 39 that is pivotally coupled at one end to a leaf spring 46. The other end of leaf spring 46 is attached to trailing arm 42. In one embodiment, actuator 39 can be extended between positions of minimum and maximum length, and can thereby establish the height at which trailer 20 is suspended from the roadway. As seen in FIGS. 14a and 14c, actuator 39 is extended to a maximum position, and thereby pushes leaf spring 46 to bias suspension arm 42 (and therefore wheel 24) to a ride height or transport position of trailer 20. FIG. 14b shows actuator 39′ at a retracted position, which thus pulls leaf spring 46 forward, causing support arm 42 to pivot, and wheel 24′ to pitch upward about the pivot axis. This position of the actuator thereby establishes the load and unload position of suspension 40′.

FIG. 15 shows a suspension system 340 similar to that shown in FIG. 14, except including a coil spring 346. FIGS. 16 and 17 show suspension systems including air springs 446 and 546. In the suspension system shown in FIG. 16, the right height is established by an electric actuator. In the system shown in FIG. 17, the right height is adjusted by changing the pressure in the airspring.

FIGS. 15a, 15b, and 15c show a suspension assembly 340 according to one embodiment of the present invention. FIGS. 15a and 15b show a side and rear perspective view of the suspension, with the floor of trailer 320 and the wheel housing 328 being removed for the sake of clarity. Suspension 340 includes a wheel 324 bearingly supported by the wheel plate 342.1 of a trailing arm 342. As best seen in FIG. 15c, wheel plate 342.1 extends forward and is rigidly coupled to a frameplate 342.2. A pair of pivoting bushing blocks 44 couple frameplate 342.2 to a lateral member of frame 322. Wheel 324 is able to pitch up and down about a pivot axis established by pivots 344. A spring 346 applies a biasing force between an upwardly extending member 342.4 of trailing arm 342 and a spring support arm 342.3, such that the support arm 342 and attached wheel bias the trailer to a position above the roadway. Suspension 340 includes a spring support arm 342.3 that is pivotally coupled at one end to suspension arm 342, and pivotally coupled at the other end to actuator 339. Spring arm 342.3 and a vertically upward extension 342.4 of support arm 342 provide opposing surfaces to react loads from spring 346. The extension 342.3 of arm 342 co-acts with an actuator as a repositionable spring support. It is understood that the attachment of suspension arm 342 to frame 322 can be by any type of connection that permits up and down pitching motion of wheel 324 about the horizontal pitching axis.

FIG. 15 show an electric actuator 339 that is pivotally coupled at one end to a spring support arm 342.3, and at the other end to the frame 22 of trailer 20. The ends of coil spring 346 are attached between the upwardly extending extension 342.4 of trailing arm 342 and support arm 342.3. In one embodiment, actuator 339 can be extended between positions of minimum and maximum length, and can thereby change the position of arm 342.3, which thereby establishes the height at which trailer 320 is suspended from the roadway. As seen in FIGS. 15a and 15c, actuator 339 is extended to a maximum position, and thereby pushes extension 342.3 (and therefore coil spring 346) to bias suspension arm 342 (and therefore wheel 324) to a ride height or transport position of trailer 320. FIG. 15b shows actuator 339′ at a retracted position, which thus pulls coil spring 346 forward, causing support arm 342 to pivot, and wheel 324′ to pitch upward about the pivot axis. This position of the actuator thereby establishes the load and unload position of suspension 340′.

FIGS. 16a, 16b, and 16c shows a suspension assembly 440 according to one embodiment of the present invention. FIGS. 16a and 16b show a side and a rear perspective view of the suspension, with the floor of trailer 420 and the wheel housing 428 being removed for the sake of clarity. Suspension 440 includes a wheel 424 bearingly supported by the wheel plate 442.1 of a trailing arm 442. As best seen in FIG. 16c, wheel plate 442.1 extends forward and is rigidly coupled to a frameplate 442.2. A pair of pivoting bushing blocks 444 couple frameplate 442.2 to a lateral member of frame 422. Wheel 424 is able to pitch up and down about a pivot axis established by pivots 444. An air spring 446 applies a biasing force between one end of the pivoting spring arm 442.3 and upward extension 442.4 support arm 442, such that the support arm and attached wheel bias the trailer to a position above the roadway. Suspension 440 includes a spring support arm 442.3 that is pivotally coupled at one end to suspension arm 442, and pivotally coupled at the other end to actuator 439. Spring arm 442.3 and a vertically upward extension 442.4 of support arm 442 provide opposing surfaces to react loads from spring 446. It is understood that the attachment of suspension arm 442 to frame 422 can be by any type of connection that permits up and down pitching motion of wheel 424 about the horizontal pitching axis.

FIG. 16 show an electric actuator 439 that is pivotally coupled at one end to pivoting spring arm 442.3, and at the other end to the frame 22 of trailer 20. The ends of air spring 446 are attached between opposing end faces of spring support arm 442.3 and vertical extension 442.4 of trailing arm 442. In one embodiment, actuator 439 can be extended between positions of minimum and maximum length, and can thereby change the position of arm 442.3, which thereby establish the height at which trailer 420 is suspended from the roadway. As seen in FIGS. 16a and 16c, actuator 439 is extended to a maximum position, and thereby pushes air spring 446 to bias suspension arm 442 (and therefore wheel 424) to a ride height or transport position of trailer 420. FIG. 16b shows actuator 439′ at a retracted position, which thus pulls air spring 446 forward (by its attachment to spring arm 442.3), causing support arm 442 to pivot, and wheel 424′ to pitch upward about the pivot axis. This position of the actuator thereby establishes the load and unload position of suspension 440′.

FIGS. 17a, 17b, and 17c show a suspension assembly 540 according to one embodiment of the present invention. FIGS. 17a and 17b show a side and rear perspective view of the suspension, with the floor of trailer 520 and the wheel housing 528 being removed for the sake of clarity. Suspension 540 includes a wheel 524 bearingly supported by the wheel plate 542.1 of a trailing arm 542. As best seen in FIG. 17c, wheel plate 542.1 extends forward and is rigidly coupled to a frameplate 542.2. A pair of pivoting bushing blocks 544 couple frameplate 542.2 to a lateral member of frame 522. Wheel 524 is able to pitch up and down about a pivot axis established by pivots 544. An air spring 546 applies a biasing force between the frame 22 (such as by attachment to apron 30.1) and vertical extension 542.4 of support arm 542, such that the support arm and attached wheel bias the trailer to a position above the roadway. Suspension system 540 includes an airspring 546 for biasing system 540 and the trailer 20 between and support and kneeling positions. The pressure within airspring 546 (and therefore the position of the trailer above the roadway) is established by a compressor (not shown). It is understood that the attachment of suspension arm 542 to frame 522 can be by any type of connection that permits up and down pitching motion of wheel 524 about the horizontal pitching axis.

FIG. 18 shows various elements of a kneeling system 650. An electric motor 652 uses a set of pinion gears to rotate a rod, the ends of the rod including a cable spool to wind a cable and thereby compress the spring of the suspension systems. In some embodiments, the motor is not provided, and the rod is turned manually with a handle from either end.

FIGS. 18a, 18b, and 18c depict a cable actuated winching system 650 according to another embodiment of the present invention. System 650 is an alternate method and apparatus for changing the position of the trailer suspension from the ride height to the loading height. Referring to FIG. 18a, system 650 includes a motorized system a cable that can pull suspension arm 642 to a low height, loading and unloading position.

As best seen in FIG. 18c, a cable 650.1 is attached at one end to suspension arm 642. Suspension arm 642 is biased to a position by a coil spring 646, the spring placing a biasing load between frame 22 (not shown) and spring support arm 642.3. Cable 650.1 extends over three pulleys 650.4 (moving upward, frontward, downward, and frontward) to a spool 650.3 that is attached to the end of a rod 650.2 (as best seen in FIGS. 18a and 18b).

Rod 650.2 is coupled to a gear set 652.1, one member of the gear set being placed on the axle of a motor 652. Motor 652 can be electrically actuated to turn any direction that rotates rod 650.2 and collects cable 650.1 about the outer diameter of spool 650.3. As depicted in FIG. 18b, when cable 650.1 is collected by spool 650.3, tension on the cable pulls suspension arm 642 in a direction to pitch upward about the horizontal rotational axis established by pivot blocks 644. FIG. 18b shows suspension 640′ in the loading configuration, with spring 646′ being compressed. Suspension 640′ can be returned to the transport configuration by rotating motor 652 in the opposite direction, and permitting spring 646′ to extend and pull cable 650.1′ from spool 650.3. It is understood that in place of (or as a backup to) the electric motor, the winching system can include a crank and handle (not shown) by which a user can manually wind the cable about the spool.

In some embodiments of the present invention, the trailer can be automatically placed in either the kneeling or transport positions by electrical actuation. As one example, trailer 20 can include a single switch for actuating both the suspension system 40 as well as the hitch assembly 26. With a single switch, the hitch actuator 26.3 places the hitch assembly in its canted-upward position, as best seen in FIGS. 10b and 11b. Simultaneously, the suspension actuator 39 (or alternatively, cable assembly motor 52) can be commanded to the kneeling position, as best seen in FIG. 14b, 15b, or 16b (or with regards to the winch, FIG. 18b). Alternatively, the simultaneous command can also be given to the compressor and pneumatic control system to place airspring 546 at the kneeling position, as best seen in FIG. 17b. It is further understood that these kneeling actuators can also be separately energized. Further, the present invention also contemplates the switches and wiring that can accompany actuator 32.3 for inward and outward sliding of extensions 32.2.

As used herein, the term means for kneeling refers to any of the text and figures described above, including the embodiments shown in FIGS. 14, 15, 16, 17, and 18 and their equivalents.

FIG. 19 shows a nesting of trailers 120. In such embodiments, the width of either the right or left lateral platforms is chosen to be less than the internal width of the center of the U-shape, so as to accommodate nesting of a lateral platform of a first trailer within the center of a second trailer.

FIG. 19 shows a pair of trailers placed in a storage configuration, the stored configuration of the trailer being indicated by a quote mark for a suffix Each trailer 20′ has its rear gate 38 removed, and each trailer 20″ is yawed 180 degrees relative to the other. A side section 32″ can be nested within the central portion 20.5 of a trailer. Further, the distance from the aftmost end of a section 32″ to the mid-gate 36 is adapted and configured such that the front alignment feature 34F and the gate 36 of the other trailer can be longitudinally accommodated.

In some embodiments of the present invention the trailers can be stored and moved around a storage lot in the fully kneeled configuration. Unlike those trailers that kneel to a position in which a part of the trailer bed comes into contact with the roadway, various embodiments of the present invention maintain a clearance height from the roadway to the bottom of the trailer platforms 32 and 33 even in the fully kneeled position. Referring to FIGS. 14, 15, 16, 17, and 18, it is appreciated that various suspension systems shown and described herein accommodate storage in the kneeled position. As one example, suspension system 650 of FIG. 18 can be electrically actuated to a fully kneeled position, and the motor 652 or spool 650.3 can be locked in position, with coil spring 646 further being locked in the fully compressed state. Referring to suspension 540 of FIG. 17, it is appreciated that deflation of airspring 546 results in placement of trailer 20 in the kneeled position, with the trailer remaining in this position until air pressure is restored to the airspring. With regard to the suspensions shown in FIGS. 14, 15, and 16, it is appreciated that placement of the actuator X39 to the kneeling position will also place the trailer in the same kneeled position, such that the trailer will remain in that position until the actuator is restored to its normal ride height position.

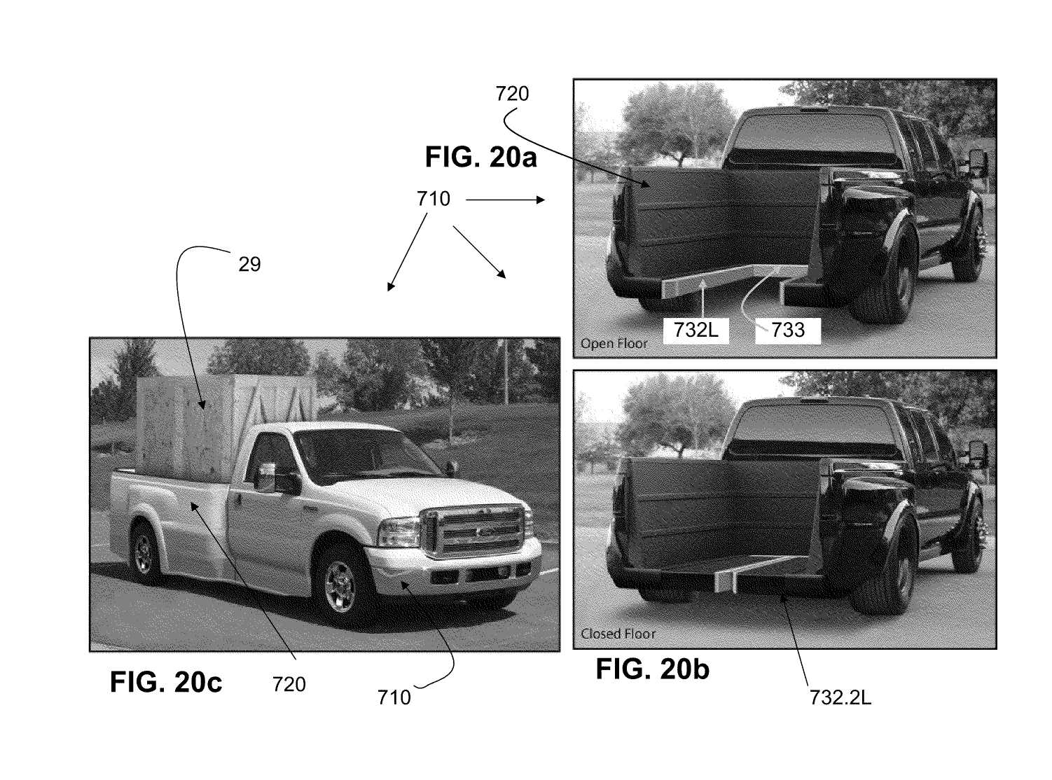

FIG. 20 show the various U-shaped frame features discussed herein as applied to the bed of a pickup truck.

FIGS. 20a, 20b, and 20c show a vehicle 710 according to another embodiment of the present invention. In one embodiment, vehicle 710 includes a cargo section 720 that includes some of the features of trailer 20. As best seen in FIGS. 20a and 20b, the cargo section 720 includes a frame 722 that has been modified to provide an opened central portion 720.5 arranged in a general U-shape 720.1. The opened end 720.4 of the U-shape is oriented toward the rear of the vehicle, to allow for loading of a container as previously described herein. Cargo section 720 includes a pair of opposite side sections or lateral platforms 732, each of which incorporates a shelf 742.1 for supporting the container load. A front section 733 is located behind the cab of vehicle 710. In some embodiments, front section 733 does not include an alignment feature 734, although other embodiments do include such an alignment feature. In one embodiment, vehicle 710 includes front and rear suspension systems capable of lowering the height of the side sections 732, such as the suspension systems disclosed in U.S. Provisional Patent Application Ser. No. 61/239,341, filed Sep. 2, 2009, entitled SUSPENSION CONVERSION KIT; U.S. Pat. No. 7,559,400, issued Jul. 14, 2009, entitled LOW PROFILE CHASSIS AND SUSPENSION; and U.S. patent application Ser. No. 12/046,176, filed Mar. 11, 2008, entitled SUSPENSIONS FOR LOW FLOOR VEHICLES, all of which are incorporated herein by reference.

FIG. 20b shows sliding extensions 733 extended inwardly to provide support of narrower cargo. FIG. 20c shows a vehicle 710 transporting a container 29 within cargo section 720. Rear gate 738 has not been shown in FIGS. 20a and 20b for sake of clarity. It is understood that a vehicle 710 can include a cargo section 720 that includes any of the features described herein for trailer 20 and its various alternatives.

While the inventions have been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. An system for transporting cargo along a surface, comprising:
a container defining an interior for holding the cargo and having a front, a pair of opposing lateral sides, and a bottom with a periphery, said bottom including a downwardly extending support structure that is recessed inwardly from the periphery of each side to define a pair of ledges along opposite sides of said bottom, the front of said container including a first alignment feature; and
a trailer supported from the surface by at least one pair of wheels, said trailer including a front section and two side sections arranged in a general U-shape, the opened central portion of the U being sized to accept therein said support structure, each said side section of said trailer having an inwardly extending shelf to receive thereupon a corresponding ledge of the bottom of said container, said trailer including a second alignment feature capable of coupling with the first alignment feature to laterally align said container relative to said trailer;
wherein the shelf of said side sections receive the weight of said container and cargo when said trailer is transporting said container, and said support structure of said container bears the weight of said container and cargo when the container is not supported on the ledges.

2. The system of claim 1 wherein said trailer has a length, and said wheels are placed about mid-way along the length.

3. The system of claim 2 wherein each said wheel is coupled to said trailer by a suspension including a spring, the suspension of each said wheel capable of biasing said trailer to a first vertical height for transport over the surface or to a second vertical height for loading a container onto said trailer.

4. The system of claim 3 wherein at the second vertical height the shelf of each side section is capable of sliding underneath a corresponding ledge of the bottom of said container.

5. The system of claim 3 wherein the spring is an airspring.

6. The system of claim 1 wherein said container has a first length, said trailer has a second length, and the second length is more than about twice the first length.

7. The system of claim 6 wherein said trailer has a movable midgate about midway along the second length, the gate being adapted and configured to restrain the axial movement of a container supported by said side sections.

8. The system of claim 7 wherein said midgate is hingedly connected to said trailer.

9. The system of claim 6 wherein said trailer is capable of supporting two said containers within the U.

10. The system of claim 1 wherein said trailer includes a movable rear gate that closes the U-shape and restrains axial movement of a container supported within the central portion of the U.

11. The system of claim 10 wherein said rear gate includes a third alignment feature capable of coupling with the first alignment feature to laterally align said container relative to said trailer.

12. The system of claim 10 wherein said rear gate is hingedly connected to said trailer.

13. The system of claim 1 wherein said support structure has a generally rectangular shape.

14. The system of claim 1 wherein the second alignment feature is a pin, and the first alignment feature is a hole.

15. The system of claim 14 wherein the pin is conically shaped.

16. The system of claim 1 wherein the first alignment feature has a shape that is complementary to the shape of the second alignment feature, with one of said first or second alignment features capable of being received within the other of said first or second alignment features.

17. The system of claim 1 wherein said container is a six-sided box.

18. A method for transporting cargo along a surface, comprising:
providing a container defining an interior for holding the cargo and a trailer having a flat platform with a U-shape;
supporting the container at a first vertical height above the surface;
supporting the top of the platform of the trailer at a second vertical height above the surface, the second height being less than the first height;
sliding the opened portion of the U underneath the container;
laterally aligning the container relative to the trailer by receiving a first feature of one of the container or the trailer within a second feature of the other of the container or trailer;
raising the platform underneath the container to a transport height greater than the first height; and
lifting the container off of the surface by said raising the platform.

19. The method of claim 18 wherein the first feature is a pair of support rails that extend downwardly from the bottom of the container and the second feature are the opposing arms of the U shape.

20. The method of claim 18 wherein the first feature is a pin extending from the closed end of the U shape of the trailer and the second feature is hole in the front of the container.

21. The method of claim 18 wherein a portion of the container extends below the top of the platform at the transport height.

22. The method of claim 18 wherein said providing includes an airspring and said raising is by adding pressure to the airspring.

23. A method for transporting cargo along a surface, comprising:
providing a pair of substantially identically containers, each container defining an interior for holding the cargo, each container having a first face that includes an alignment feature and a second face, and a trailer having a U-shaped platform with an opened end and a closed end and a movable gate capable of spanning across the opened end;
supporting the first container within the U-shape and coupling the alignment feature of the first container to the closed end of the U;
supporting the second container within the U-shape and behind the first container, the second face of the second container being adjacent to the second face of the first container;
moving the gate to span the opened end of the U; and
coupling the alignment feature of the second container to the gate.

24. The method of claim 23 wherein the movable gate is hingedly connected to the trailer to rotate about a vertical axis, and said moving is by swinging the gate.

25. The method of claim 23 wherein the movable gate is a first movable gate and the trailer includes a second movable gate capable of spanning across the arms of the U, and which further comprises moving the second gate to span across the U in front of the second container and behind the first container.

26. An towable trailer for transporting a container over a surface, comprising:
a platform supported from the surface by a pair of wheels, said platform including a front section and two side sections arranged in a general U-shape, at least a portion of the U-shape being planar, the rear of the U shape being open;
each said wheel being coupled to a different said side section by a corresponding suspension, each said suspension being adapted and configured for biasing said platform to a first vertical height for transporting the container over the surface or to a second, lower vertical height for loading the container onto said platform;
a first movable gate located about midway along the longitudinal length of one said side section, said first gate being adapted and configured to span across at least a portion of the open channel of the U and restrain the longitudinal movement of a container supported on the platform; and
a second movable gate located at the rear of one said side section, said second gate being adapted and configured to span across at least a portion of the open channel of the U and restrain the longitudinal movement of a container supported on the platform.

27. The trailer of claim 26 wherein said front section includes an alignment feature for coupling with the container.

28. The trailer of claim 27 wherein the alignment feature is one of a projection or a receptacle.

29. The trailer of claim 26 wherein each said suspension includes an airspring.

30. The trailer of claim 26 wherein each side section has a maximum lateral width from the inboard edge of the side section to the outboard edge of the side section, and the maximum later width is less than the distance from the inboard edge of one side section to the inboard edge of the other side section.

31. The trailer of claim 26 wherein said first movable gate is hingedly connected to the one said side section, and the hinge axis is generally horizontal.

32. The trailer of claim 31 wherein each said wheel is located within a corresponding wheel housing, and the hingable connection is to one said wheel housing.

33. The trailer of claim 26 wherein said first movable gate is repeatedly separable from said platform, and said first gate spans from one said side section to the other said side section.

34. The trailer of claim 33 wherein each said wheel is located within a corresponding wheel housing, and said first gate is supported by each said wheel housing.

35. The trailer of claim 26 wherein said second movable gate is hingedly connected to the one said side section, and the hinge axis is generally vertical.

36. The trailer of claim 26 wherein said second movable gate is repeatedly separable from said platform, and said first gate spans from one said side section to the other said side section.

37. The system of claim 1 wherein said trailer includes means for kneeling the height of said trailer from a first position for transporting to a second position for loading of a container.

38. The system of claim 37 wherein said kneeling means includes a suspension arm and spring coupling each said wheel to said trailer, and the spring is an air spring.

39. The system of claim 38 which further comprises an actuator movable between two positions, wherein said spring has two ends, and one end is coupled to said suspension arm and the end is coupled to an end of said actuator.

40. The system of claim 37 wherein said kneeling means includes a suspension arm and spring coupling each said wheel to said trailer, and the spring is a leaf spring.

41. The system of claim 37 wherein said kneeling means includes a trailing arm and spring coupling each said wheel to said trailer, and the spring is a coil spring.

42. The system of claim 41 which further comprises a suspension arm pivotally coupled to said trailing arm and an actuator having two ends, one end of said actuator being coupled to said trailer and the other end being coupled to said suspension arm, said spring providing a biasing load between said suspension arm and said trailing arm.

43. The trailer of claim 26 which further includes a separable container having a longitudinal length, wherein the distance from the first gate to the front of the platform is adapted and configured to receive therein the length of the container, and the distance from the second gate to the front gate is adapted and configured to receive therein the length of the container.
